(19) United States
(12) Patent Application Publication
(10) Pub. No.: US 2010/0326797 A1
(43) Pub. Date: Dec. 30, 2010

(54) CARRIER FOR TRANSPORTING SOLAR CELL SUBSTRATES

(75) Inventor: Peter G. Borden, San Mateo, CA (US)

Correspondence Address: DIEHL SERVILLA LLC, 33 WOOD AVE SOUTH, SECOND FLOOR, SUITE 210, ISELIN, NJ, 08830, US

(73) Assignee: Applied Materials, Inc., Santa Clara, CA (US)

(21) Appl. No.: 12/766,263

(22) Filed: Apr. 23, 2010

Related U.S. Application Data
(60) Provisional application No. 61/172,067, filed on Apr. 23, 2009.

(51) Int. Cl. B65G 17/00; B65H 1/00

(52) U.S. Cl. 198/793; 414/805

(57) ABSTRACT

A carrier for transporting a plurality of solar cell substrates comprising a peripheral frame defined by a pair of side members connected by first and second complementary end members, a plurality of cross struts, a plurality of standoffs for supporting the substrates, and at least one drive member coupled to one of the end members. The end members have alternating bends that provide a wave-like pattern of projections and indentations, are arranged in a spaced and substantially parallel orientation, and are constructed from metal wire. Each cross strut is connected to the first end member and the second end member between complementary projections and indentations. Rotation of the drive member causes both end members to rotate in a circular motion.

### CROSS REFERENCE TO RELATED APPLICATION

This application claims the benefit of priority under 35 U.S.C.§119(e) to U.S. Patent Application No. 61/172,067, filed Apr. 23, 2009, which is hereby incorporated by reference in its entirety.

### BACKGROUND

Embodiments of the present invention generally relate to solar cells, and in particular involve an improved carrier and methods for transporting substrates on which the solar cells are formed from one location to another.

In order to manufacture solar cell devices, various processing steps are required. The silicon substrates on which the solar cells are formed must be transferred from one location to another inside a production facility. Various prior art substrate handling systems have been developed to transport the substrates from processing chamber to processing chamber and are currently in use. These devices include, for example, belt systems, Bernoulli grippers and walking beams. Belts similar to O-rings transport are relatively inexpensive and can be utilized to pass wafers from cassettes to process tools. They are commonly employed on wet benches and screen print tools. However, belt systems are not used in vacuum tools. Although metal belts have been utilized in furnaces, they present a risk of metallic contamination and therefore are undesirable for this application. Bernoulli grippers, which are commonly utilized to load and unload pallets, employ the Bernoulli effect to lift individual wafers with minimal contact. The usefulness of Bernoulli grippers is severely limited by the need for an intricate articulating arm and the capacity to handle only one wafer at a time. For high-temperature zones in furnace systems, walking beams involving ceramic rods have been utilized as wafer transfer tools. In addition, the commercially available ATON system manufactured by Applied Materials uses pallets made of carbon composite or metal to transfer wafers.

There are several additional disadvantages associated with these technologies. First, they all require pallets that have large surface areas and thus require considerable space. Pallets made of carbon composite also have internal cavities which can carry adsorbed gases into the process area. Contamination can result, especially in processes requiring high temperatures. In addition, an expensive automation system having pick-and-place robots is needed to load and unload the pallets. The cost of this system can comprise one-third of the capital cost of the ATON process node. Furthermore, the robots may handle the top surface of each wafer and thereby introduce additional contamination. Moreover, because of their high thermal mass, the pallets cannot be used in some hot processes.

Thus, there is a need for a relatively low-cost substrate handling system that is compatible with high process temperatures.

### SUMMARY OF THE INVENTION

One embodiment of the present invention relates to a carrier for transporting a plurality of solar cell substrates. The carrier includes a peripheral frame that is defined by a pair of side members connected by first and second complementary end members and enclosing a solar cell substrate-conveying region. The carrier also includes a plurality of cross struts that are connected to the first and second end members, a plurality of standoffs spaced from each other on each cross strut, and at least a first drive member coupled to one of the end members.

The pair of side members that define the frame are in a spaced and substantially parallel orientation. The side members are connected by first and second complementary end members, which have alternating bends to provide a wave-like pattern of projections and indentations. The end members are in a spaced and substantially parallel orientation such that the distance between a projection of the first end member and a complementary indentation of the second end member is substantially equal to the distance between an indentation of the first end member and a projection of the second end member. In one or more embodiments, the first and second end members may be constructed from metal wire. The least a first drive member that is coupled to one of the end members such that rotation of the drive member causes the first end member and the second end member to rotate in a circular motion. In one or more embodiments, the each of the first and second end members is coupled to the first drive member, which rotates the end members in a circular motion. Alternative embodiments utilize a pair of drive members coupled to each of the first and second end members.

The plurality of cross struts is connected to the first end member and the second end member between complementary projections and indentations. The cross struts are separated from each other in the substrate-conveying region by sufficient distance to support a solar cell substrate. The plurality of standoffs is spaced from each other on each cross strut and is utilized for supporting the substrates. In one or more embodiments, the standoffs are spaced from each other at a distance in the range of about 2 cm to about 7 cm. In one or more embodiments, the each standoff may include a base that is substantially coplanar with the cross strut on which it lies and may also include an extending apex on which the substrates rest. In operation, the substrates are transported from the apex of one standoff to the apex of the adjacent standoff on each cross strut. In one or more embodiments, the plurality of standoffs can have varying shapes and may be constructed from either ceramic or glass material. For example, each standoff may have a pyramidal shape or may have a conical shape.

In one or more embodiments, the rotation of the one or more drive members causes a pair of cross struts, which are coupled to projections of the first end member and complementary indentations of the second member, to synchronously rotate. The rotation of the one or more drive members also causes another pair of cross struts, which are coupled to indentations of the first end member and complementary projections of the second member to synchronously rotate. The synchronous rotation of both pairs of cross struts forms a walking beam conveying apparatus.

One or more embodiments of the invention are directed toward solar cell processing apparatus comprising the carrier, as described herein. In one or more embodiments, a first end of the carrier may be arranged adjacent to a conveying system and arranged to load substrates on the carrier. A second end of the carrier may also be arranged adjacent to a substrate loading chamber for loading substrates into a processing chamber. The apparatus according to one or more embodiments may also include sensors for sensing the arrival of substrates at the carrier.

Additional embodiments of the invention are directed to methods of conveying solar cell substrates to a loading apparatus. The methods comprise placing at least one wafer on a plurality of spaced apart cross members including end portions synchronously rotating such that the cross members form a walking beam that laterally moves the substrate in a lateral direction. The methods also include unloading the substrates from the walking beam to a loading chamber in a load lock arrangement with a solar cell processing apparatus.

One or more embodiments of the methods described herein may also include sensing the position of the substrate on the plurality of spaced apart cross members, disposing the substrate on standoffs such that the substrate does not contact the cross member and disposing the walking beam between a conveyor that loads plurality of substrates on the walking beam and the loading chamber. Alternative embodiments of the method may utilize standoffs that have varying shapes, such as pyramidal or conical. The standoffs used in one or more embodiments may also be made of ceramic and/or glass materials.

The foregoing has outlined rather broadly certain features and technical advantages of the present invention. It should be appreciated by those skilled in the art that the specific embodiments disclosed may be readily utilized as a basis for modifying or designing other structures or processes within the scope present invention. It should also be realized by those skilled in the art that such equivalent constructions do not depart from the spirit and scope of the invention as set forth in the appended claims.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a top plan view of a substrate carrier according to an embodiment of the present invention;

FIGS. 2A-2B illustrate various standoffs for use with one or more embodiments of the invention;

FIG. 3 illustrates a side view of a substrate carrier according to the an embodiment of the present invention; and

FIG. 4 illustrates a side view of a substrate carrier according to an embodiment of the present invention transferring a substrate from a cassette to a loadlock chamber.

### DETAILED DESCRIPTION OF THE INVENTION

Before describing several exemplary embodiments of the invention, it is to be understood that the invention is not limited to the details of construction or process steps set forth in the following description. The invention is capable of other embodiments and of being practiced or being carried out in various ways.

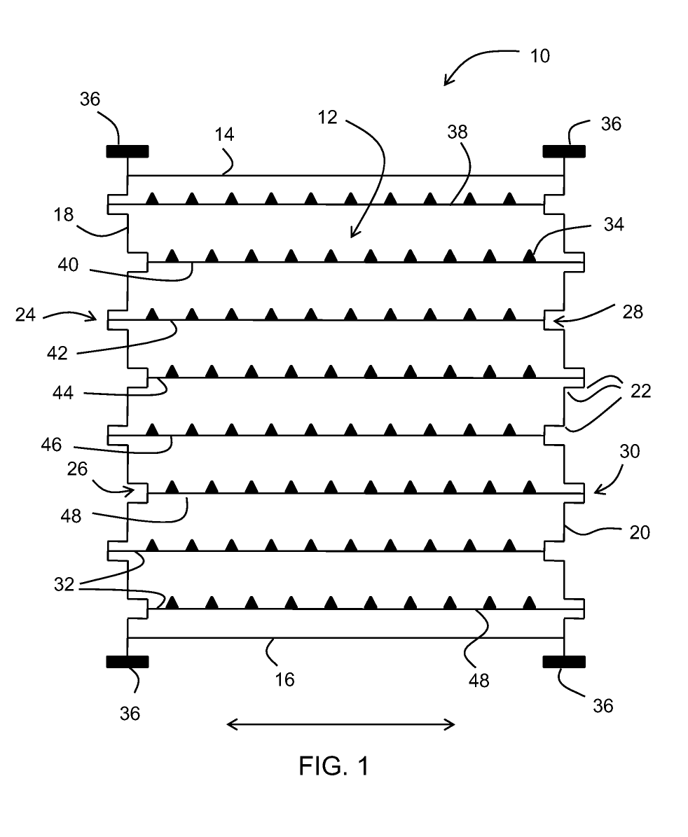

FIG. 1 shows an exemplary embodiment of a carrier. The carrier comprises a peripheral frame 10 enclosing a substrate-conveying region 12. The frame 10 is defined by two opposing side members 14 and 16 configured in a spaced and substantially parallel orientation. The side members 14 and 16 are connected by a first end member 18 and a second end member 20. Each of the end members 18 and 20 has bends 22 that alternate to provide a wave-like pattern of projections 24, 30 and indentations 26, 28. The end members 18 and 20 are configured in a spaced and substantially parallel orientation such that the distance between a projection 24 of the first end member 18 and a complementary indentation 28 of the second end member 20 is substantially equal to the distance between an indentation 26 of the first end member 18 and a projection 30 of the second end member 20. Preferably, the end members 18 and 20 are constructed from metal wire.

According to one or more embodiments of the invention, the bends are spaced in the range of about 1 to about 10 mm apart, when measured from one projection to the adjacent projection on the same end member. Other embodiments of the invention have the bends spaced at a distance in the range of about 2 to about 7 mm apart, or about 3 to about 6 mm apart. In detailed embodiments the bends are spaced at a distance not more than about 12 mm, 11 mm, 10 mm, 9 mm, 8 mm, 7 mm, 6 mm, or 5 mm apart. In other detailed embodiments the bends are spaced at a distance not less than about 1 mm, 2 mm, 3 mm, 4 mm or 5 mm apart. In specific embodiments, the bend spacing can be in the range of any of the previously mentioned minimums to maximum amounts.

A plurality of cross struts 32 are connected to the first end member 18 and the second end member 20 between complementary projections and indentations. The number of cross struts 32 varies depending upon operational requirements and the area of the substrate-conveying region 12. The cross struts 32 are separated from each other by sufficient distance to support a standard solar cell substrate. It will be appreciated that the size of solar cell substrates varies in accordance with industry standards.

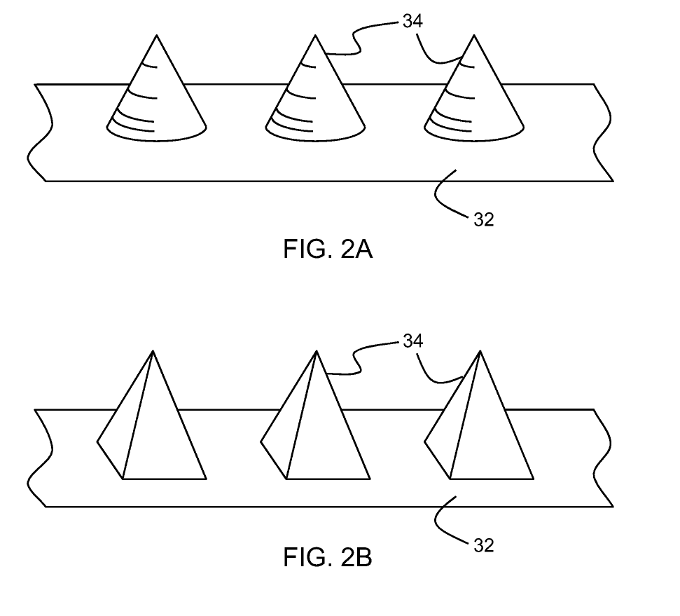

In some embodiments of the invention, a plurality of standoffs 34, spaced from each other on each cross strut 32, are used to support the substrates. The standoffs 34, can assume a variety of shapes and configurations. FIGS. 2A and 2B illustrate possible shapes for the standoffs 34. For example, each standoff 34 of FIG. 2A has a pyramidal shape including a base substantially coplanar with the cross strut 32 on which it lies and an outwardly extending apex on which a solar cell substrate can rest. FIG. 2B shows standoffs 34 having a conical shape. While the standoffs 34 have been described a conical or pyramidal shape, this should not be considered limiting the invention. Other shapes and configurations are contemplated and remain within the scope of the invention. The standoffs 34 can be integrally formed with the strut 32, or a separate piece which has been affixed to the strut 34. Any suitable material, such as glass or a ceramic for example, can be utilized to construct the standoffs. Ceramic standoffs may be especially desirable for use in high-temperature processes.

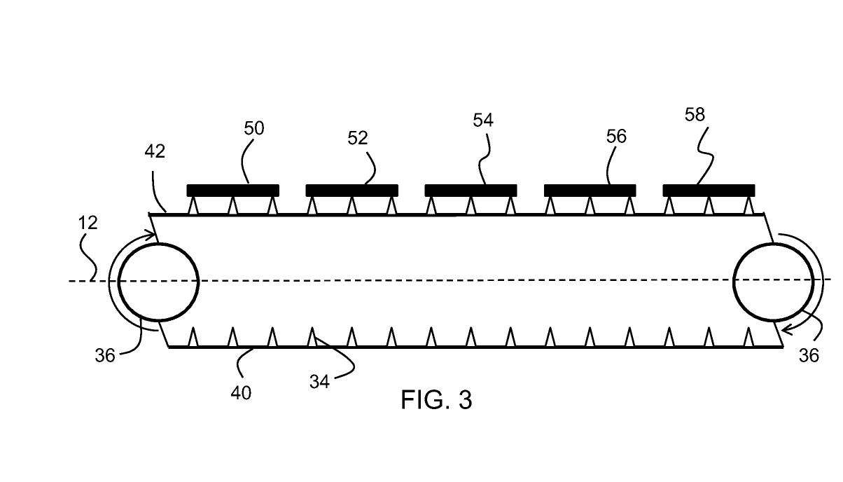

In operation, the carrier functions as a walking beam. The operation of the carrier is described with respect for FIGS. 1 and 3. Solar cell substrates 50, 52, 54, 56, 58 are placed on the apexes of the plurality of standoffs 34, or on the cross struts 32 if no standoffs 34 are employed. At least one drive member 36 is coupled to one of the end members 18 or 20 such that rotation of the drive member 36 causes the first end member 18 and the second end member 20 to rotate in synchronous circular motion. Due to their configurations, adjacent cross struts 32 are out of phase by 180°. For example, when the drive member 36 rotates sufficiently, alternating cross struts 32 are positioned above the plane defined by the substrate-conveying region 12, with the intermediate struts 32 positioned below the plane. For example, cross struts 38, 42, 46, 48 etc. may be supporting the substrates 50, 52, 54, 56 and 58 above the plane of the substrate-conveying region 12, while intermediate struts 40, 44, 46, etc. are below the plane. Further rotation of the drive member 36 causes the cross struts above the plane to rotate below the plane while the cross struts below the plane are rotated above the plane. As the cross struts, or standoffs 34, are at the same level, the substrate(s) will be transferred from the first set of struts to the second set of struts. In this manner, the substrates are transported from the first side member 18 to the second side member 20, or vice versa depending on the direction of rotation of the drive member 36.

FIG. 3 presents a side view of the carrier in operation. A plurality of solar cell substrates 50, 52, 54, 56 and 58 are being transported among the standoffs 34 by rotation of the drive members 36. One of the most advantageous and useful aspects of the present invention is its versatility. The carrier can transport substrates in various stages of the solar cell manufacturing process.

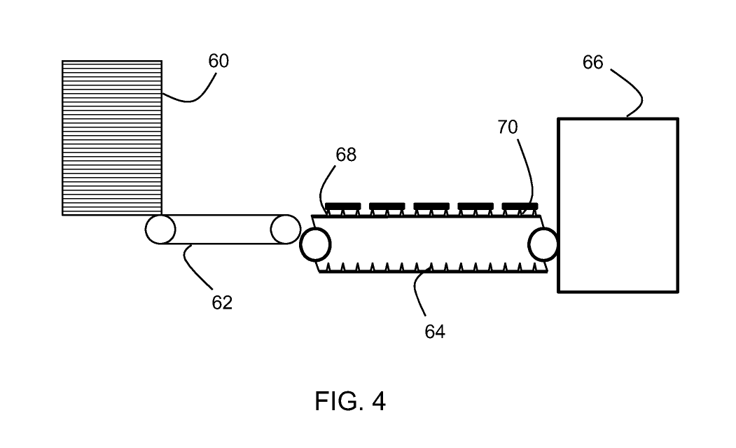

FIG. 4 depicts two potential uses of the carrier described herein. A first end 68 of the carrier is positioned adjacent to a conveying system 62, such as a belt transport mechanism, that loads and unloads solar cell substrates from a cassette 60. The second end 70 of the carrier 64 is arranged adjacent to a loading unit 66, such as a loadlock chamber, that transfers substrates to and from a processing chamber. In one embodiment of the invention, the carrier 64 transfers substrates from the conveying system 62 to the loading unit 66. According to another embodiment of the invention, the carrier 64 transfers the substrates from the loading unit 66 to the conveying system 62. Sensors for detecting arrival of substrates at the carrier 64 may optionally be provided.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

1. A carrier for transporting a plurality of solar cell substrates, comprising:
a peripheral frame enclosing a solar cell substrate-conveying region, the frame defined by a pair of side members in a spaced and substantially parallel orientation connected by first and second complementary end members having bends alternating to provide a wave-like pattern of projections and indentations, the end members in a spaced and substantially parallel orientation such that the distance between a projection of the first end member and a complementary indentation of the second end member is substantially equal to the distance between an indentation of the first end member and a projection of the second end member;
a plurality of cross struts connected to the first end member and the second end member between complementary projections and indentations, the cross struts being separated from each other in the substrate-conveying region by sufficient distance to support a solar cell substrate;
a plurality of standoffs for supporting the substrates, the standoffs being spaced from each other on each cross strut; and
at least a first drive member coupled to one of the end members such that rotation of the drive member causes the first end member and the second end member to rotate in a circular motion.

2. The carrier for transporting a plurality of solar cell substrates of claim 1, wherein each standoff has a pyramidal shape including a base substantially coplanar with the cross strut on which it lies and an outwardly extending apex.

3. The carrier for transporting a plurality of solar cell substrates of claim 2, wherein each standoff has a conical shape.

4. The carrier for transporting a plurality of solar cell substrates of claim 3, wherein the substrates rest on the apexes of the standoffs.

5. The carrier for transporting a plurality of solar cell substrates of claim 4, wherein the substrates are transported from the apex of one standoff to the apex of the adjacent standoff on each cross strut.

6. The carrier for transporting a plurality of solar cell substrates of claim 5, wherein the first end member and the second end member are constructed from metal wire.

7. The carrier for transporting a plurality of solar cell substrates of claim 6, wherein the standoffs are separated by a distance in the range of about 2 cm to 7 cm.

8. The carrier for transporting a plurality of solar cell substrates of claim 7, wherein the standoffs are constructed from a ceramic material.

9. The carrier for transporting a plurality of solar cell substrates of claim 7, wherein the standoffs are constructed from a glass material.

10. The carrier for transporting a plurality of solar cell substrates of claim 1, wherein each of the first end member and second end member are coupled to a drive member for rotating the end members in a circular motion.

11. The carrier for transporting a plurality of solar cell substrates of claim 10, wherein each of the first end member and second end member are coupled to a pair of drive members.

12. The carrier for transporting a plurality of solar cell substrates of claim 1, wherein rotation of the drive member causes a first pair of cross struts coupled to projections of the first end member and complementary indentations of the second end member to synchronously rotate and a first pair of cross struts coupled to indentations of the first end member and complementary projections of the second end member to synchronously rotate to form a walking beam conveying apparatus.

13. A solar cell processing apparatus comprising the carrier of claim 12, a first end of the carrier arranged adjacent to a conveying system arranged to load substrates on the carrier, and a second end of the carrier arranged adjacent to a substrate loading chamber for loading substrates into a processing chamber.

14. The solar cell processing apparatus of claim 13, further comprising sensors for sensing arrival of substrates at the carrier.

15. A method of conveying solar cell substrates to a loading apparatus comprising:
placing at least one wafer on a plurality of spaced apart cross members including end portions synchronously rotating such that the cross members form a walking beam that laterally moves the substrate in a lateral direction; and
unloading the substrates from the walking beam to a loading chamber in a load lock arrangement with a solar cell processing apparatus.

16. The method of claim 15, further comprising sensing the position of the substrate on the plurality of spaced apart cross members.

17. The method of claim 15, further comprising disposing the substrate on standoffs such that the substrate does not contact the cross members.

18. The method of claim 17, further comprising disposing the walking beam between a conveyor that loads a plurality of substrates on the walking beam and the loading chamber.

19. The method of claim 17, wherein the standoffs are pyramidal in shape.

20. The method of claim 19, wherein the standoffs comprise ceramic material.
